(19) United States
(12) Patent Application Publication
(10) Pub. No.: US 2006/0239745 A1
(43) Pub. Date: Oct. 26, 2006

(54) Keyboard structure

(75) Inventor: Wen-Hui Tao, Taipei County (TW)

Correspondence Address: J-power International Co., Ltd., P.O. Box No. 6-57, Junghe, Taipei, 235, TW

(73) Assignee: J-power International Co., Ltd.

(21) Appl. No.: 11/111,810

(22) Filed: Apr. 22, 2005

(51) Int. Cl. B41J 5/00

(52) U.S. Cl. 400/472

(57) ABSTRACT

A keyboard structure primarily consists of a keyboard body which contains an amplification circuit connected with a microphone socket, a headphone socket and trumpets, a USB socket, an IEEE1394 socket and jacks located at proper positions of the keyboard. The keyboard structure can be provided for listening to music or voice transmitted by a computer through the headphone or trumpets, and for constituting a function of dialoging through the microphone. Whereas, the jacks located at the keyboard body can be used for inserting a device such as a snake-lamp or fan, thereby improving a value of practicability of the keyboard.

### BACKGROUND OF THE INVENTION

(a) Field of the Invention

The present invention relates to a keyboard structure, and more particularly to a keyboard structure that can provide a function of transmitting computer music or voice to constitute a talking function and can provide for installing different accessories to facilitate a more diversified application of a keyboard.

(b) Description of the Prior Art

Except for connecting to a computer to provide a function of keying data or texts, there is no other additive function for an ordinary keyboard. As a population of network, listening to music on a network or constituting an on-line dialog through a network transmission is gradually accepted by a user nowadays. However, usually in talking, a headphone or a microphone needs to be inserted into a connection port of a host computer, or an external trumpet needs to be used for receiving voice signals, which is very inconvenient and creates disorder in connection, and thus is not a perfect application.

### SUMMARY OF THE INVENTION

The primary object of the present invention is to provide an improved keyboard structure having functions of receiving and sending speeches, and capable of installing other accessories, so as to improve a value of practicability of a keyboard.

The aforementioned keyboard structure is provided with a keyboard body containing an amplification circuit which is connected with sockets of a microphone and a headphone and trumpets. In addition, a USB(Universal Serial Bus) socket, an IEEE1394 socket, and jacks are located at proper positions of the keyboard, so as to listen music or voice transmitted from a computer through a headphone or trumpets, thereby avoiding a problem in connecting with a host computer.

Accordingly, the aforementioned keyboard structure is provided with trumpets located at two sides of an upper part, middle positions at a lower part, or other proper positions.

Accordingly, the aforementioned keyboard structure is provided with jacks for inserting an accessory such as a snake-lamp, a fan, or a CCD(Charge Coupled Device), so as to facilitate an assembly of such accessories.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a structural view of the present invention.

FIG. 3 shows a schematic view of an implementation of the present invention.

### DETAILED DESCRIPTION OF THE PREFERRED EMBODIMENTS

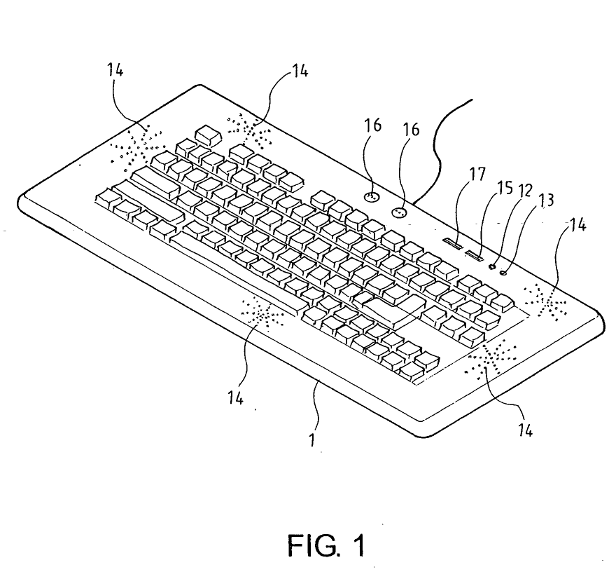

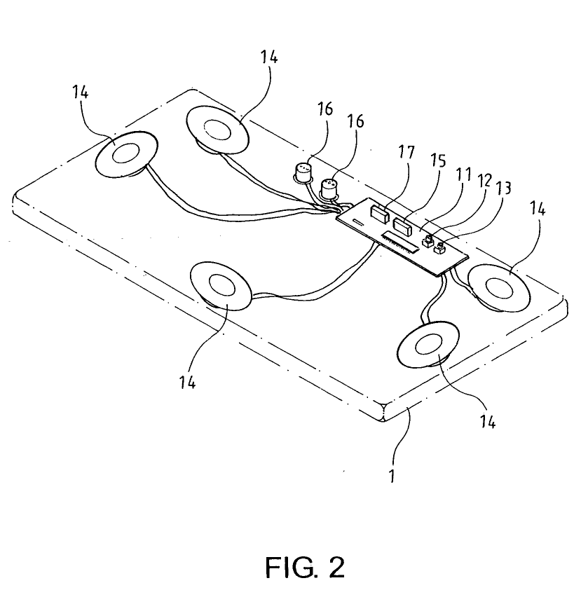

Referring to FIG. 1 to FIG. 2, it shows a perspective view and a structural view of the present invention. The present invention comprises primarily a keyboard body 1 containing an amplification circuit 2 which is connected with a microphone socket 12 and a headphone socket 13, and trumpets 14 located at two sides of an upper part, middle positions at a lower part, or other proper positions of the keyboard 1. A USB socket 15 and an IEEE1394 socket 17 are mounted at an upper part of the keyboard body 1, whereas jacks 16 are located at one side of the socket 15. By assembling the aforementioned compartments, the keyboard 1 can be used for receiving computer music or voice, and outputting the voice from the trumpets 14, so as to avoid a problem in installing external trumpets for a host computer. In addition, the sockets 12, 13 can be used for inserting a microphone and a headphone respectively, so as to constitute functions of receiving and sending speeches through the microphone and the headphone, thereby facilitating a connection of the headphone and the microphone. Whereas the jacks 16 of the keyboard body 1 can be used for inserting an accessory such as a snake-lamp, a fan, or CCD, so as to provide for connecting with different accessories in addition to provide for an ordinary input function to a computer, thereby improving a value of practicability of the keyboard body 1.

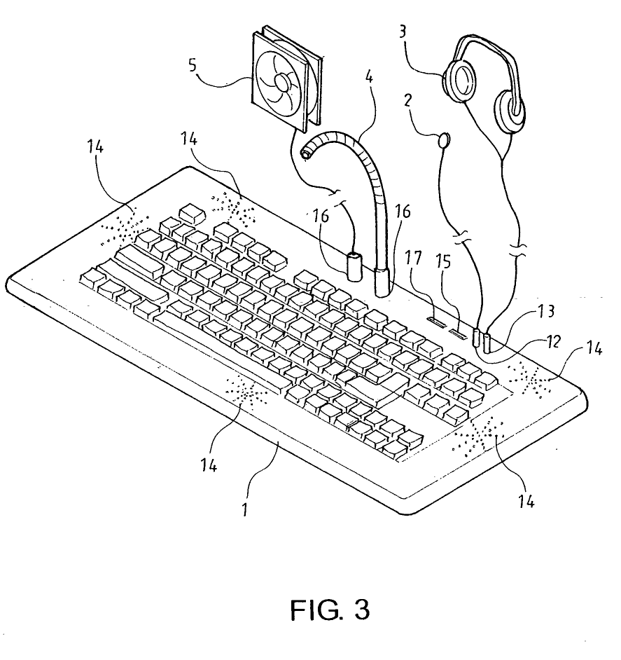

Referring to FIG. 3, it shows a schematic view of an implementation of the present invention. Upon using the present invention, the microphone 2 and the headphone 3 can be inserted into the sockets 12 and 13 respectively to constitute a function of dialoging. On the other hand, voice of speeches can be directly output through the trumpets 14 if the headphone 3 is not used. Whereas, the jacks 16 located at an upper part can be used for inserting an accessory such as a snake-lamp 4, a fan 5 or a CCD. Accordingly, an ordinary device for sending and receiving voice can be installed on the keyboard body 1 without using extra connection means, which is very convenient upon using. Moreover, the snake-lamp 4 and fan 5 inserted into the jacks 16 require no other connection with a computer, thereby avoiding a disorder caused by too many connection lines.

Accordingly, the present invention includes a keyboard body provided with trumpets, sockets of a headphone and a microphone, and various jacks, so as to improve a value of practicability of the keyboard.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A keyboard structure including primarily a keyboard body which contains an amplification circuit connected with trumpets, a headphone and a microphone, a USB socket, an IEEE1394 socket and jacks located at a surface of the body, enabling the microphone and headphone to be inserted into the keyboard for constituting a function of dialoging, or for sending computer voice through the trumpets; the jacks used for inserting an accessory such as a snake-lamp, a fan, or a CCD, thereby improving a value of practicability of the keyboard.

2. The keyboard structure according to claim 1, wherein the trumpets are located at two sides of an upper part, middle positions at a lower part, or other proper positions.
